(19) United States
(12) Patent Application Publication
(10) Pub. No.: US 2024/0157620 A1
(43) Pub. Date: May 16, 2024

(54) POLYMERIC ARTICLES WITH ELECTRONIC CODE FORMED THEREON AND PROCESS OF MAKING THE SAME

(71) Applicant: Berry Global, Inc., Evansville, IN (US)

(72) Inventors: Jared B. WATERMAN, Evansville, IN (US); Jonathan EICKHOFF, Evansville, IN (US); Jennye SCOTT, Evansville, IN (US); Kirk BIRCHLER, Mount Vernon, IN (US); Jeffrey A. MANN, Evansville, IN (US)

(21) Appl. No.: 18/511,287

(22) Filed: Nov. 16, 2023

Related U.S. Application Data
(60) Provisional application No. 63/425,826, filed on Nov. 16, 2022.

(51) Int. Cl. B29C 48/00; B23K 26/362; B29C 48/07; B29C 48/16

(52) U.S. Cl. CPC B29C 48/0023; B23K 26/362; B29C 48/0017; B29C 48/0022; B29C 48/07; B29C 48/16; B29C 2793/009

(57) ABSTRACT

An article forming system includes an extruder configured to extrude a sheet of polymeric material and a thermoforming device configured to form the sheet into a plurality of article preforms a carrier web coupled to each of the article preforms. Polymeric articles formed from the article preforms include encoded visual indicia.

### PRIORITY CLAIM

This application claims priority under 35 U.S.C. § 119(e) to U.S. Provisional Application Ser. No. 63/425,826, filed Nov. 16, 2022, which is expressly incorporated by reference herein in its entirety.

### BACKGROUND

The present disclosure relates to polymeric articles, and particularly to polymeric articles with visual features formed thereon. More particularly, the present disclosure relates to polymeric articles with electronic code included thereon.

### SUMMARY

According to the present disclosure, an article forming system includes an extruder, a thermoforming device, and a trimming unit. The extruder is configured to extrude a sheet of polymeric material in a downstream direction. The thermoforming device is configured to form the sheet into a plurality of article preforms and a carrier web interconnecting each of the article preforms. The trimming unit is configured to separate each of the article preforms from the carrier web to produce polymeric articles such as bottle caps, for example.

In illustrative embodiments, the article forming system includes a laser etching unit configured to laser etch features into each of the article preforms. The laser etching unit includes a laser, a laser actuator unit, and a control system. The laser is configured produce a laser beam when energized. The laser actuator unit is configured to move the laser beam relative to the plurality of article preforms so that the laser forms the encoded visual indicia on the plurality of article preforms. The control system controls operation of the laser and the laser actuator unit to form the encoded visual indicia on the surface of the article preform.

In illustrative embodiments, the encoded visual indicia is be configured to be scanned by a computing device having an optical camera to cause the computing device to generate instructions based on the scanned encoded visual indicia. The instructions may cause the computing device to display augmented reality that allows the user to interact with the augmented environment, cause an image and/or text to be displayed on a screen of computing device, cause a sound to be played from a speaker connected with computing device, or cause the computing device to take a user to a predetermined website. In some embodiments, the encoded visual indicia is used in an industrial setting such as a recycling facility.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1A is a diagrammatic view of an article forming system including an extruder configured to extrude a sheet of polymeric material, a rotary thermoforming device configured to mold the sheet to include a plurality of article preforms and a carrier web interconnecting each of the article preforms, a laser etching unit configured to etch machine-readable electronic code onto a surface of each of the plurality of article preforms, and a cutting unit configured to separate each of the article preforms from the carrier web to produce a plurality of polymeric articles with encoded visual indicia that can be scanned with an optical camera and processed by a computing device to generate instructions and/or show an augmented reality on a device used by a user;

FIG. 1B is a top plane view of one of the polymeric articles with the encoded visual indicia formed thereon;

FIG. 2 is a perspective view of the laser etching unit from FIG. 1A showing three rows of article preforms coupled to the carrier web and being conveyed downstream past a plurality of lasers included in the laser etching unit, the plurality of lasers including at least one laser for each row of article preforms such that each article preform can be individually and separately etched apart from the other article preforms;

FIG. 3 is an enlarged view of one of the lasers included in the laser etching unit suggesting that the laser is reciprocated in a transverse direction to a direction of travel of the article preforms to form the encoded visual indicia into the article preform as the article preforms are advanced downstream in the direction of travel;

FIG. 4 is a flowchart showing steps in which a polymeric article can be formed and then laser etched to with encoded visual indicia;

FIG. 5 is a perspective view of a polymeric article having a first pattern of encoded visual indicia formed thereon on a first portion of the polymeric article and a second patter of encoded visual indicia formed thereon on a second portion of the polymeric article separate from the first portion;

FIG. 6 is a perspective view similar to FIG. 5 showing another embodiment of a polymeric article including the first pattern of encoded visual indicia formed thereon and the second pattern of encoded visual indicia formed thereon and interspersed with the first pattern of encoded visual indicia;

FIG. 7 is a perspective view showing another embodiment of a polymeric article including a first pattern of encoded visual indicia and a second pattern of encoded visual indicia, the first pattern communicating a first piece of information to a user visually and the second pattern communicating a second piece of information in augmented reality after the encoded visual indicia is scanned by a user;

FIG. 8 is a perspective view showing another embodiment of a polymeric article including a first pattern of encoded visual indicia and a second pattern of encoded visual indicia, the first pattern configured to form a raised embossment on the polymeric article and communicating a first piece of information to a user visually, the second pattern communicating a second piece of information in augmented reality after the encoded visual indicia is scanned by a user;

FIG. 9 is a perspective view showing another embodiment of a polymeric article including first pattern of encoded visual indicia and a second pattern of encoded visual indicia, the first pattern of features and second patterns overlapping with one another and being formed to include a raised embossment such that the first pattern and second pattern visually communicate a first piece of information to a user and the first pattern and the second pattern communicate a second piece of information in augmented reality after the encoded visual indicia is scanned by a user; and

FIG. 10 is another embodiment of an article forming system including a flatbed thermoforming device configured to mold a sheet of polymeric material to include a plurality of article preforms and a carrier web interconnecting each of the article preforms, a trimming unit which separated each of the article preforms from the carrier web to provide a plurality of articles and flips the articles, and a laser etching unit configured to etch machine-readable electronic code onto a surface of each of the plurality of article preforms that can be scanned with an optical camera and processed by a computing device to generate instructions and/or show an augmented reality on a device used by a user.

### DETAILED DESCRIPTION

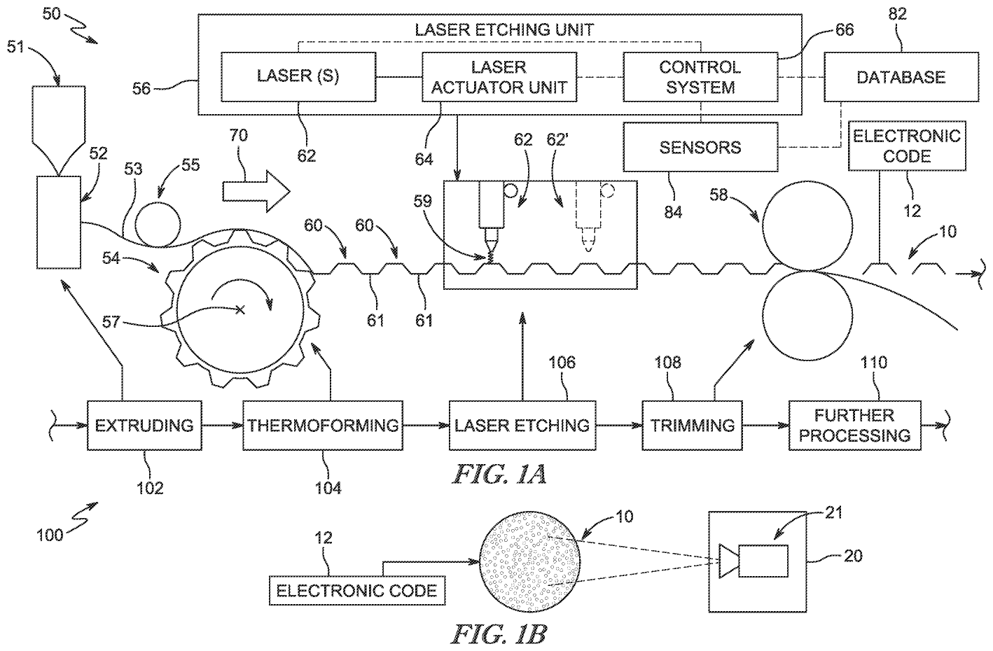

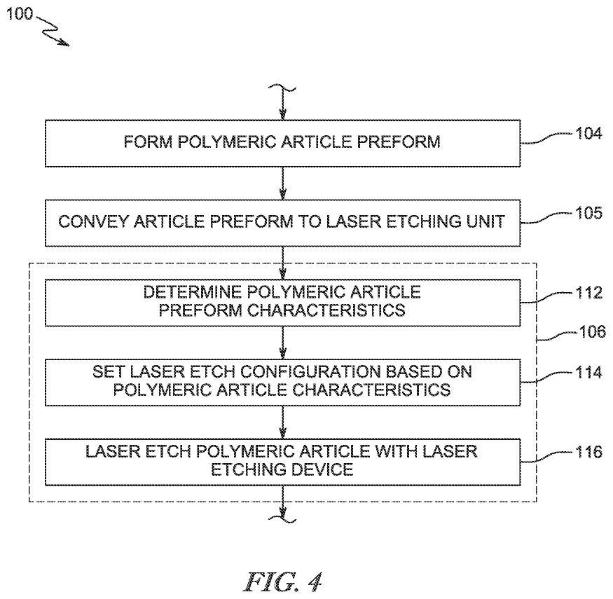

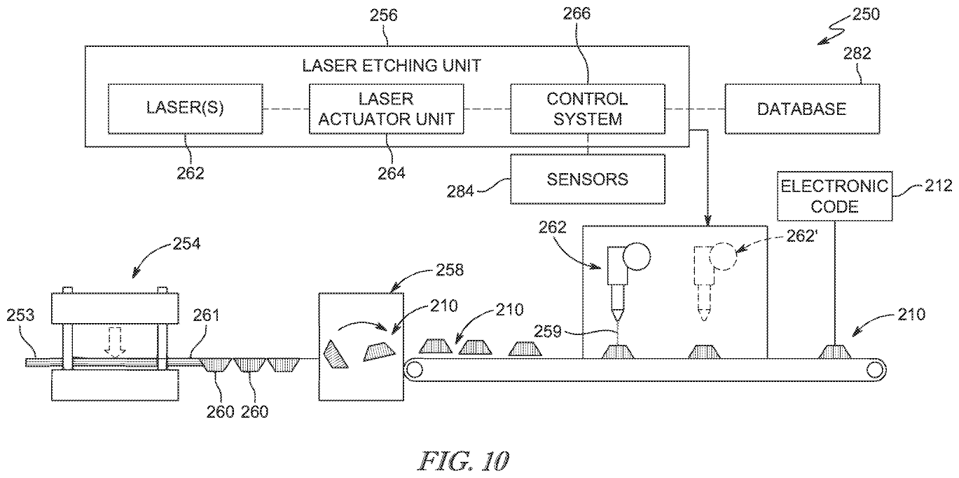

An article forming system 50, in accordance with the present disclosure, is configured to form a plurality of polymeric articles 10 having encoded visual indicia 12 formed thereon that can be scanned by an optical camera 21 of a device 20 as shown in FIGS. 1A and 1B. The article forming system 50 is configured to form the polymeric articles 10 using a process or method 100 as shown in FIGS. 1A and 4. The encoded visual indicia 12 is formed directly onto a surface of each of the polymeric articles 10 by laser etching during the process 100. Another embodiment of an article forming system 250 is shown in FIG. 10.

The article forming system 50 includes an extruder 52, a rotary thermoforming device 54, a laser etching unit 56, and a trimming unit 58 as shown in FIG. 1. The extruder 52 is configured to receive bulk polymeric material from a material source 51, such as a hopper, and is configured to form and extrude a sheet of polymeric material 53. The sheet 53 is conveyed downstream by one or more carrier rollers 55. The rotary thermoforming device 54 is configured to rotate about an axis 57 and is configured to form the sheet 53 into a plurality of article preforms 60 and a carrier web 61 which interconnects each of the plurality of article preforms 60. The laser etching unit 56 is configured to produce a laser beam 59 as the plurality of article preforms 60 are advanced past the laser etching unit 56 to form encoded visual indicia 12 on each of the article preforms 60. The trimming unit 58 is configured to separate each of the article preforms 60 from the carrier web 61 to produce a plurality of polymeric articles 10 having the encoded visual indicia 12 formed thereon.

The laser etching unit 56 includes one or more lasers 62, a laser actuator unit 64, and a control system 66 as shown in FIG. 1A. The laser(s) 62 is configured to produce the laser beam 59 when energized. The laser actuator unit 64 is configured to move at least one of the laser(s) 62 and the laser beam 59 relative to the article preforms 60 along a predetermined path to etch the encoded visual indicia 12 into a surface of the article preforms 60 as the article preforms 60 are advanced downstream past the laser(s) 62. The control system 66 is configured to send command signals to both the laser(s) 62 and the laser actuator unit 64 to cause the laser(s) 62 to energize in predetermined intervals and to cause the laser beam 59 to move along the predetermined path so that the encoded visual indicia 12 is formed in the surface of each article preform 60.

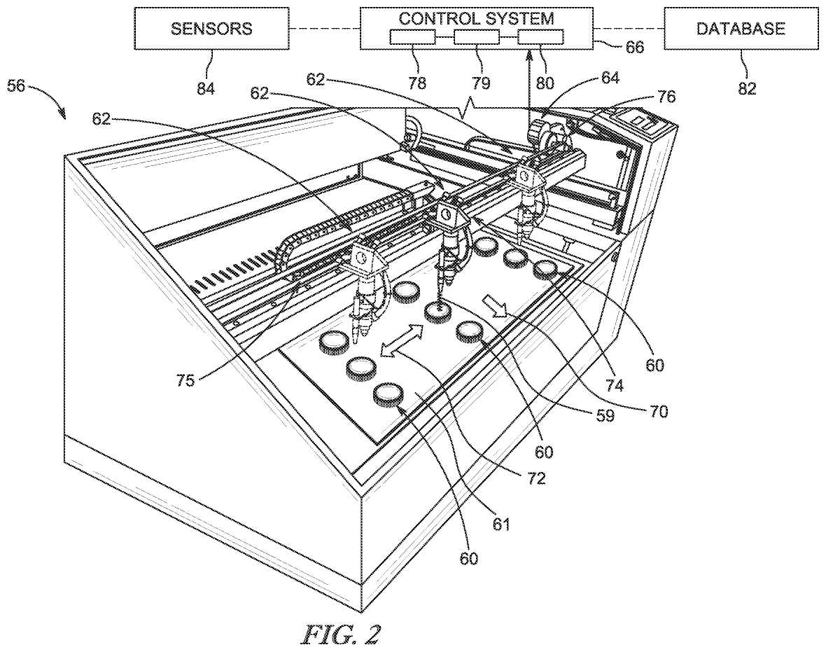

The rotary thermoforming device 54 may form only on row of article preforms 60 into the sheet 53. However, in the illustrative embodiment, the rotary thermoforming device 54 is configured to form a plurality of rows of article preforms 60 into the sheet 53 as shown in FIG. 2. Each row of article preforms 60 is spaced apart from one another in a transverse direction 72 to a direction of travel 70 of the article preforms 60 and the carrier web 61.

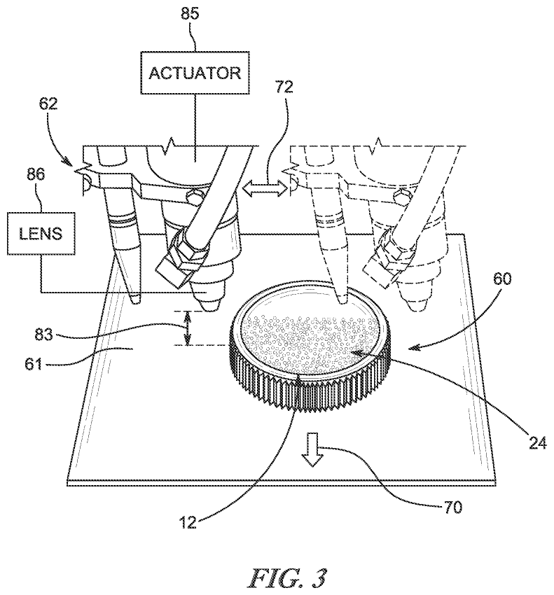

In some embodiments, a single laser 62 is moved in the transverse direction 72 relative to the plurality of rows of article preforms 60 by the laser actuator unit 64. The laser actuator unit 64 is configured to reciprocate the laser beam 59 back and forth in the transverse direction 72 across each of the article preforms 60 as suggested in FIG. 3. In the illustrative embodiment, the laser actuator unit 64 includes a laser mount 74, a laser conveyor 75, and a laser motor 76. The laser mount 74 is arranged to lie above the plurality of article preforms 60 and is configured to support the laser 62. The laser conveyor 75 is coupled between the laser mount 74 and the laser 62. The laser motor 76 is configured to move the laser conveyor 75 and the laser 62, which is fixed thereto, in the transverse direction 72. In some embodiments, the laser motor 76 is configured to move the laser mount 74 relative to the article preforms 60 and the laser 62 is fixed in position on the laser mount 74 such that the laser conveyor 75 is omitted. In yet another embodiment, the laser motor 76 is coupled directly to the laser 62 and is configured to move the laser 62 relative to the laser mount 74 along a track.

The control system 66 is configured to synchronize when the laser 62 is energized as the laser 62 passes over each article preform 60 so that laser 62 periodically energizes in a predetermined sequence to form the encoded visual indicia 12 on each article preform 60. The control system 66 includes a processor 78, a memory storage device 79, and circuitry 80 as shown in FIG. 2. The processor 78 is coupled electrically to each of the laser(s) 62 and the laser actuator unit 64 via the circuitry 80. The memory storage device 79 is coupled to the processor 78 and stores instructions that, when executed by the processor 78, cause the laser(s) 62 to energize and to cause the laser actuator unit 64 to move the laser beam 59 relative to the plurality of article preforms 60 to form the encoded visual indicia 12 thereon. In some embodiments, the control system 66 is configured to energize the laser 62 such that the same pattern of encoded visual indicia 12 is formed on each row of article preforms 60 as the laser beam 59 reciprocates in the transverse direction 72. In some embodiments, the control system 66 is configured to energize the laser 62 such that a different pattern of encoded visual indicia 12 is formed on one or more rows of article preforms 60 from the rest of the rows. In some embodiments, the control system 66 is configured to energize the laser 62 such that a different pattern of encoded visual indicia 12 is formed on each row of article preforms 60.

In some embodiments, the laser etching unit 56 includes a plurality of lasers 62 coupled to the laser mount 74 and spaced apart from one another in the transverse direction 72 as suggested in FIG. 2. In this embodiment, at least one laser 62 may be associated with each row of article preforms 60. Each laser 62 may be coupled to the laser mount 74 for movement therewith or to the laser conveyor 75 for movement therewith. In some embodiments, each laser 62 moves together in the same direction 72 with one another by a single laser motor 76. Thus, each of the lasers 62 reciprocate in the transverse direction 72 relative to the plurality of article preforms 60 at the same rate and speed. In some embodiments, the control system 66 may cause each laser 62 to energize at the same time so that the same pattern of encoded visual indicia 12 is applied to each article preform 60. In some embodiments, the control system 66 is configured to energize one or more lasers separately from the other lasers 62 so that one or more rows of article preforms 60 are formed with a different pattern of encoded visual indicia 12 from one another. In some embodiments, the control system 66 is configured to energize each laser 62 at different times so that a different pattern of encoded visual indicia 12 is formed on each row of article preforms 60.

In other embodiments, each laser 62 includes a respective laser motor 76 and/or a respective laser conveyor 75 and is configured to move independently of one another. In such an embodiment, each of the lasers 62 may reciprocate in the transverse direction 72 at different rates and/or speeds and may be energized at different times by the control system 66 to form different patterns of encoded visual indicia 12 on each row of article preforms 60.

In some embodiments, the laser etching unit 56 may include a plurality of columns of lasers 62, 62′ as shown in FIG. 1. Each of the columns of lasers 62, 62′ is coupled to the control system 66 and can be individually controlled by the control system 66. Each column of lasers 62, 62′ may be configured to form encoded visual indicia on different article preforms 60 so that the travel speed of the article preforms 60 in travel direction 70 can be increased. For example, a first column of lasers 62 may be configured to form encoded visual indicia 12 on a first article preform while a second column of lasers 62′ is configured to form the encoded visual indicia 12 on a second article preform spaced apart from the first article preform in the travel direction 70. The first and second article preforms may be etched by each respective column of lasers 62, 62′ at the same time or at different times relative to one another. In some embodiments, the first column of lasers 62 is configured to form a first portion of the encoded visual indicia 12 into an article preform 60 and, subsequently, the second column of lasers 62′ is configured to form a second portion of the encoded visual indicia 12 into the article preform 60. Together, the first and second portions of the encoded visual indicia 12 may complete the total pattern for the encoded visual indicia 12. The laser etching unit 56 may include more columns of lasers in addition to columns 62, 62′ in some embodiments.

The control system 66 is configured to adjust the positioning of the lasers 62 relative to the plurality of article preforms 60 and/or an intensity or magnitude of the laser beam 59 emitted from each laser 62 in response to data indicative of characteristics of the article preforms 60 as suggested in FIGS. 1A and 2. The data may include information indicative of a material composition of the article preforms 60, a color of the article preforms 60, or other material properties of the article preforms 60 such as rigidity, compression/tensile strength, reflection/refraction index, transparency, clarity, density, or any other material property.

The positioning of the lasers 62 and/or the intensity or magnitude of the laser beam 59 emitted from each laser 62 is adjusted so that the encoded visual indicia 12 is formed with a sufficient resolution that can be read from the optical camera 21 of a computing device 20 depending on the material composition and/or color of the article preform 60. Some materials and/or colors make the encoded visual indicia 12 more difficult for optical cameras 21 to read. Thus, the control system 66 is configured to adjust the lasers 62 to either increase the readability of the encoded visual indicia 12 on materials and/or colors which are difficult to read, or decrease power consumption when the encoded visual indicia 12 is being formed on materials and/or colors that are easier to read.

Each of the lasers 62 and/or the laser actuator unit 64 may include a vertical actuator 85 which is configured to increase or decrease a distance 83 between each laser 62 and each of the article preforms 60 as shown in FIG. 3. Decreasing distance 83 corresponds with at least one of: more focused etchings, increased etching pattern density, more intense laser beam 59, higher magnitude laser beam 59, higher temperature laser beam 59, etc. Thus, the encoded visual indicia 12 formed by the laser beam 59 may be more readable by an optical camera 21 when the distance 83 is decreased. Conversely, increasing distance 83 corresponds with at least one of: less focused etchings, decreased etching pattern density, less intense laser beam 59, lower magnitude laser beam 59, lower temperature laser beam 59, etc. The lasers 62 may be able to form encoded visual indicia 12 on the article preforms 60 at a higher rate when the distance 83 is increased. Thus, the article forming system 50 can be optimized for greater article output and/or decreased power consumption while still forming encoded visual indicia 12 that is readable by an optical camera 21.

In some embodiments, the intensity or magnitude of the laser beam 59 may be increased or decreased depending on the characteristics of the article preforms 60. The intensity or magnitude of the laser beam 59 may be adjusted independently or in conjunction with adjustment of distance 83. Increasing laser beam 59 intensity or magnitude corresponds with at least one of: more focused etchings, increased etching depth, etc. Thus, the encoded visual indicia 12 formed by the laser beam 59 may be more readable by an optical camera 21 when the laser beam intensity or magnitude is increased. Decreasing laser beam 59 intensity or magnitude corresponds with at least one of: less focused etchings, decreased etching depth, etc. However, some material compositions or colors may still be readable with such etching characteristics. The lasers 62 may be able to form encoded visual indicia 12 on the article preforms 60 at a higher rate when the laser beam 59 intensity or magnitude is decreased. Thus, the article forming system 50 can be optimized for greater article output and/or decreased power consumption while still forming encoded visual indicia 12 that is readable by an optical camera 21. Each laser 62 may include an adjustable lens 86 which can adjust focus, intensity, and/or magnitude of the laser beam 59. Power input into each laser 62 may also adjust laser beam intensity or magnitude.

In illustrative embodiments, materials having a higher rigidity may require at least one of decreased distance 83 and/or increased laser beam 59 intensity or magnitude to form readable encoded visual indicia 12 compared to less rigid materials. In illustrative embodiments, materials having a higher density may require at least one of decreased distance 83 and/or increased laser beam 59 intensity or magnitude to form readable encoded visual indicia 12 compared to less dense materials. In illustrative embodiments, materials having a higher density may require at least one of decreased distance 83 and/or increased laser beam 59 intensity or magnitude to form readable encoded visual indicia 12 compared to less dense materials. In illustrative embodiments, materials having a lower color wavelength may require at least one of decreased distance 83 and/or increased laser beam 59 intensity or magnitude to form readable encoded visual indicia 12 compared to higher color wavelength materials. In illustrative embodiments, less reflective materials may require at least one of decreased distance 83 and/or increased laser beam 59 intensity or magnitude to form readable encoded visual indicia 12 compared to more reflective materials. In illustrative embodiments, materials having a lower refractive index may require at least one of decreased distance 83 and/or increased laser beam 59 intensity or magnitude to form readable encoded visual indicia 12 compared to materials having a higher refractive index. In illustrative embodiments, materials having a higher transparency may require at least one of decreased distance 83 and/or increased laser beam 59 intensity or magnitude to form readable encoded visual indicia 12 compared to materials having a lower transparency.

In one example, an article preform 60 having a black color requires a decreased distance 83 and/or increased laser beam 59 intensity or magnitude to form readable encoded visual indicia 12 thereon compared to an article preform 60 having a red or yellow color. Table 1 below describes various articles with encoded visual indicia 12 formed thereon and the laser beam 59 intensity or magnitude as a percent value of total possible intensity or magnitude (power) for one illustrative laser 62 that can be used to etch the article preforms 60. It should be appreciated that other lasers may produce readable encoded visual indicia at other values and/or percentages of total possible intensity or magnitude.

TABLE 1

| | Power | Speed | Readable by |
|---|---|---|---|
| Color | (%) | (%) | camera 21? |
| Black | 55 | 100 | No |
| Black | 60 | 100 | No |
| Black | 63 | 100 | No |
| Black | 65 | 100 | Yes |
| Black | 66 | 100 | Yes |
| Red | 55 | 100 | Yes |
| Red | 60 | 100 | Yes |
| Yellow | 55 | 100 | Yes |
| Yellow | 60 | 100 | Yes |

The data associated with the characteristics of the article preforms 60 may be obtained from one or more different sources which provide signals to the control system 66 as suggested in FIGS. 1A and 2. In one example, the data is stored in a database 82 which is coupled to the control system 66 and used by the control system 66 to automatically adjust the settings of the laser etching unit 56 in response to the data to form readable encoded visual indicia 12 on each article preform 60. The data may be manually input into the database 82 or automatically determined by one or more sensors 84. The sensors 84 may include optical sensors, infrared sensors, or any other suitable type of sensor 84 that can determine the characteristics of the article preforms 60.

The encoded visual indicia 12 (sometimes called encoded information or electronic code) may be scanned by an optical camera 21 of a computing device 20 such as, for example, a mobile device, kiosk, or an industrial facility application as suggested in FIG. 1B. The encoded visual indicia 12 may be used for various consumer, commercial, personal, or industrial applications. Once encoded visual indicia 12 is scanned, computing device 20 generates instructions based on the scanned encoded visual indicia 12. As a non-exhaustive list of examples, the instructions may cause the computing device to display augmented reality that allows the user to interact with the augmented environment, cause an image and/or text to be displayed on a screen of computing device 20, cause a sound to be played from a speaker connected with computing device 20, or cause the computing device to take a user to a predetermined website. The instructions may include information related to article 10 such as, for example, the materials from which article 10 is made for recyclability purposes, the date, time, and/or location of the manufacture of article 10, or the contents stored in article 10. In general, any suitable programmable instructions may be generated in response to scanning encoded visual indicia 12.

Illustratively, the encoded visual indicia 12 is provide by a plurality of depressions and/or protrusions formed in article 10 which are arranged in a predetermined pattern as suggested in FIG. 1B. The depressions extend downward away from a top surface of article 10 in the embodiment shown in FIG. 1. In other embodiments, the features may extend upwardly from the top surface and, therefore, may be called protrusions instead of depressions. Though the features are 3-dimensional, they may provide 2-dimensional shapes for the optical camera to scan. As such, the optical camera is configured to detect a pattern of 3-dimensional embossments or 2-dimensional indicia such as circles, lines, curves, or other discrete shapes such as squares, triangles, ovals, etc.

Article 10 may be for example, a lid or cap 10 for a container as shown in FIG. 3, a cup, a bowl, a tray, a plate, a film, a container such as a pill container, storage container, tamper-evident container, a damage or tamper-evident indicator, an information indicator selector, a bottle, a cap, a closure, or any other suitable article. Illustratively, article 10 is a shallow draw article formed with a rotary thermoforming process, however aspects of the present disclosure may be incorporated in other article forming processes by a different polymeric-article forming device such as, for example, deep draw thermoforming, blow molding, injection molding, casting, molding on a tread of molds, flatbed thermoforming, compression molding, etc.

Manufacturing process 100 is illustratively an article-manufacturing process 100 for forming articles 10 as shown, for example, in FIGS. 1A, 4, and 5-9. Article-manufacturing process 100 includes an extrusion stage 102, a molding or thermoforming stage 104, a laser etching stage 106, an separating or trimming stage 108, and one or more further processing stages 110. Extrusion stage 102 provides molten polymeric material that is used during the forming stage 104 to produce one or more article preforms 60. The polymeric material may be conditioned prior to forming stage 104.

As previously described, the article preforms 60 may be formed during forming stage 104 by a rotary thermoforming process, deep draw thermoforming, blow molding, injection molding, casting, molding on a tread of molds, flatbed thermoforming, or any other suitable forming process. Once formed, each article preform 60 can be laser etched by laser etching unit 56 during laser etching stage 106. After or before the laser etching stage 106, the article preforms 60 may be separated from carrier web 61 during separating stage 108. The articles 10 may also be trimmed during separating stage 108. The articles 10 may then be packaged for storage or transportation during further processing stage 110. The articles may also be labeled or printed during further processing stage 110.

In some embodiments, extrusion stage 102 includes extruding the polymeric material in the form of a sheet 53 of polymeric material. The sheet 53 may be conditioned to establish a desired surface finish, temperature, and feed rate of sheet 53. Forming stage 104 applies sheet 53 to a mold 54 to form article preforms 60 and carrier web 61. Illustratively, forming stage 104 may include rotary thermoforming sheet 53. In other embodiments, molding stage 104 is replaced with another forming stage such as flatbed thermoforming, as shown in FIG. 10, casting, injection molding, or blow molding. In some embodiments, the sheet 53 of polymeric material is applied directly from extrusion stage 102 to molding stage 106 or another forming stage without being conditioned. Following the forming stage 104, the article preforms 60 and the carrier web 61 are conveyed to the laser etching unit 56 at stage 105.

During the laser etching stage 106, the laser etching unit 56 reconfigures itself to form encoded visual indicia 12 that is readable by the optical camera 21. The control system 66 of the laser etching unit 56 is configured to determine polymeric article preform characteristics during a step 112 as shown in FIG. 4. The characteristics may be determined from one or both of database 82 and sensor(s) 84. In response to the characteristics determined, the control system 66 is configured to adjust and set laser 62 configuration at step 114. This may include one or both of adjusting distance 83 and/or adjusting laser beam 59 intensity or magnitude. Once the laser 62 configuration is set, the article preforms 60 are conveyed under the laser 62 and are etched by the laser 62 to provide scannable encoded visual indicia 12 thereon during step 116.

During laser etching stage 106, the article preforms 60 are laser etched to provide a plurality of features 24 on lid on each article preform 60. The plurality of features 24 may include holes, cells, lobes, nodes, wells, spikes, another feature shape, or a combination of two or more of these features. The plurality of features 24 may include a single pattern that repeats multiple times on article preforms 60. The patterns may each be arranged at different orientations relative to a datum reference point, such as a center of the article preform 60, for example. In some embodiments, the articles 10 are laser etched after trimming stage 108.

The size, shape, and spacing of the features 24 provide the encoded visual indicia 12 with a pattern that is scannable with the optical camera 21. For example, the size of the features 24 or protrusions and the spacing between features 24 or protrusions on preforms 60 may be chosen to maximize repeatable and successful scanning of the encoded visual indicia 12 provided by the features 24 by the optical camera 21. Illustratively, the encoded visual indicia 12 may be scanned by the optical camera 21 at any orientation relative to the article 10 without any orienting features being formed and included with encoded visual indicia 12.

In some embodiments, the plurality of features 24 each have a depth (also called a height) within a range of about 0.005 inches to about 0.02 inches. In some embodiments, the plurality of features 24 each have a depth (or height) within a range of about 0.005 inches to about 0.015 inches. In some embodiments, the plurality of features 24 each have a depth (or height) within a range of about 0.005 inches to about 0.01 inches. In some embodiments, the plurality of features 24 each have a depth (or height) less than about 0.02 inches. In some embodiments, the plurality of features 24 each have a depth (or height) less than about 0.015 inches. In some embodiments, the plurality of features 24 each have a depth (or height) less than about 0.01 inches. In some embodiments, the plurality of features 24 each have a depth (or height) equal to about 0.01 inches. In some embodiments, the plurality of features 24 each have a depth (or height) equal to about 0.005 inches.

In some embodiments, the plurality of features 24 are each about 0.007 inches in diameter (or width). In some embodiments, the plurality of features 24 are each about 0.010 inches in diameter. In some embodiments, the plurality of features 24 are each about 0.012 inches in diameter. In some embodiments, the plurality of features 24 are each about 0.014 inches in diameter. In some embodiments, the plurality of features 24 are each about 0.016 inches in diameter. In some embodiments in which a shape different than a circle is used, the values indicated can refer to a length, width, or thickness of the features rather than a diameter.

In some embodiments, the plurality of features 24 are each between about 0.005 inches in diameter and about 0.020 inches in diameter. In some embodiments, the plurality of features 24 are each between about 0.007 inches in diameter and about 0.016 inches in diameter. In some embodiments, the plurality of features 24 are each between about 0.007 inches in diameter and about 0.012 inches in diameter. In some embodiments, the plurality of features 24 are each between about 0.010 inches in diameter and about 0.014 inches in diameter. In some embodiments, the plurality of features 24 are each between about 0.0010 inches in diameter and about 0.016 inches in diameter. In some embodiments, the plurality of features 24 are each between about 0.007 inches in diameter and about 0.014 inches in diameter. In some embodiments, all features 24 of the plurality of features 24 are about the same size as the other features 24. In some embodiments, the features 24 may be a variety of sizes compared with the other features in article preform 60.

In some embodiments, the plurality of features 24 includes a density (i.e. features or waxels per inch (WPI)) greater than 50 WPI. In some embodiments, the plurality of features 24 includes a density greater than 60 WPI. In some embodiments, the plurality of features 24 includes a density greater than 70 WPI. In some embodiments, the plurality of features 24 includes a density greater than 80 WPI. In some embodiments, the plurality of features 24 includes a density greater than 90 WPI. In some embodiments, the plurality of features 24 includes a density greater than 100 WPI. In some embodiments, the plurality of features 24 includes a density greater than 110 WPI. In some embodiments, the plurality of features 24 includes a density greater than 120 WPI. In some embodiments, the plurality of features 24 includes a density greater than 130 WPI. In some embodiments, the plurality of features 24 includes a density greater than 140 WPI. In some embodiments, the plurality of features 24 includes a density greater than 150 WPI. WPI may be referred to as watermark resolution. Reference is made to U.S. Publication No. 2019/0306385, U.S. Publication No. 2021/0253318, and U.S. application Ser. No. 17/955,707, each of which is expressly incorporated herein in its entirety for the purpose of describing suitable watermark resolutions that may be included in article preform 60. If there is any disagreement between the reference and this disclosure, this disclosure shall control.

In some embodiments, the plurality of features 24 includes a density within a range of about 50 WPI to about 200 WPI. In some embodiments, the plurality of features 24 includes a density within a range of about 75 WPI to about 175 WPI. In some embodiments, the plurality of features 24 includes a density within a range of about 100 WPI to about 160 WPI. In some embodiments, the plurality of features 24 includes a density within a range of about 125 WPI to about 160 WPI. In some embodiments, the plurality of features 24 includes a density within a range of about 125 WPI to about 150 WPI. In some embodiments, the plurality of features 24 includes a density of about 150 WPI. The term about is used herein to account for manufacturing and/or measurement tolerances and may include values within 5 percent of the values indicated above.

The plurality of features 24 may include more than one pattern of features 24 on a single preform 60. For example, an article preform 522 includes a plurality of features 524 having a first pattern 540 and a second pattern 542 separate from and different than the first pattern 540 as shown in FIG. 5. The first pattern 540 is located on a first half of article preform top wall 523. The second pattern 542 is located on an opposite second half of article preform top wall 523. Illustratively, the first pattern 540 is shown with each feature 524 being an open circle and the second pattern 542 is shown with each feature being a closed circle, however, it should be appreciated that these shapes are exemplary and any suitable shape may be used for features 524. In some embodiments, each feature 524 has a similar shape in both first pattern 540 and second pattern 542 and the arrangement of the features 524 is different between first pattern 540 and second pattern 542. In some embodiments, the features 524 in first pattern 540 have a different shape than the features 524 in second pattern 542. The plurality of features 524 are repeated and have shapes similar to features 24 described above, thereby increasing aesthetics of the article 10 while providing the encoded visual indicia 12.

The first pattern 540 may be scanned by an optical camera 21 of a consumer computing device 20 to generate a first set of instructions based on the first pattern 540 in the encoded visual indicia 12. The first set of instructions may cause the consumer computing device 20 to display augmented reality that allows the user to interact with the augmented environment, cause an image or text to be displayed on a screen of computing device 20, cause a sound to be played from a speaker connected with computing device 20, or cause the computing device to take a user to a predetermined website. The consumer computing device 20 may include memory with preprogrammed instructions such that the second pattern 542 is ignored by the industrial computing device when scanned by the optical camera of the industrial computing device. In other embodiments, the second pattern 542 may have an arrangement that is unreadable from the optical camera of a consumer computing device (i.e. a smartphone).

The second pattern 542 of encoded visual indicia 12 may be scanned by an optical camera of an industrial computing device that is different from consumer computing device 20 to generate a second set of instructions based on the second pattern 542 in the encoded visual indicia 12. The second set of instructions may include information related to article 10 for recyclability purposes such as, for example, the materials from which article 10 is made so that the article 10 may be properly sorted. The industrial computing device may include memory with preprogrammed instructions such that the first pattern 540 is ignored from the optical camera of the industrial computing device. In other embodiments, the first pattern 540 may have an arrangement that is unreadable from the optical camera of an industrial computing device.

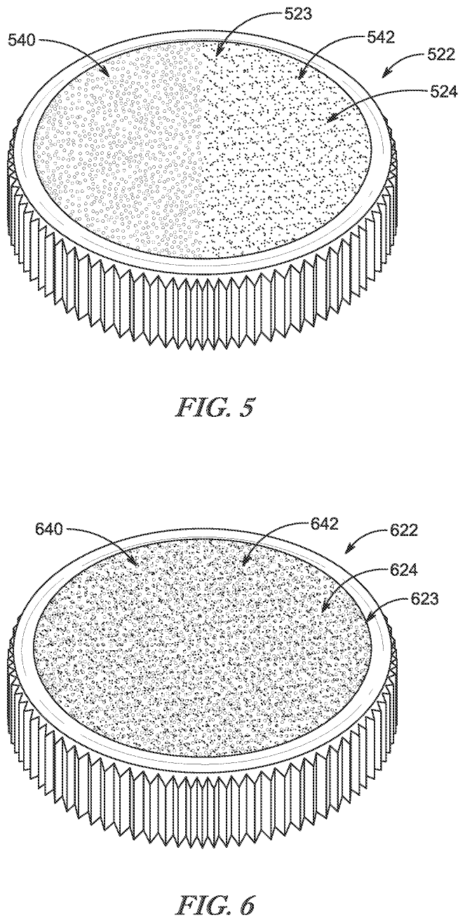

In another embodiment, an article preform 622 includes a plurality of features 624 having a first pattern 640 and a second pattern 642 interspersed with and different from the first pattern 640 as shown in FIG. 6. The article preform 622 includes an article preform top wall 623. First pattern 640 and second pattern 642 collectively provide encoded visual indicia 12 on lid or article 10 once fully processed. An entire surface of the article 10 includes both the first pattern 640 and the second pattern 642 such that a visual appearance of the encoded visual indicia 12 is perceived as a single pattern.

In some embodiments, computing devices may include memory with instructions that, when scanning encoded visual indicia 12 with an optical camera of the computing device, ignore one of the first pattern 640 and the second pattern 642. For example, a consumer computing device 20 may ignore second pattern 642 while an industrial computing device may ignore first pattern 640. In this way, the encoded visual indicia 12 can provide different instructions for different types of computing devices using a plurality of patterns while the overall appearance of the article is perceived as a single pattern visually by a consumer. The plurality of features 624 are repeated and have shapes similar to features 24 described above, thereby increasing aesthetics of the article 10 while providing the encoded visual indicia 12.

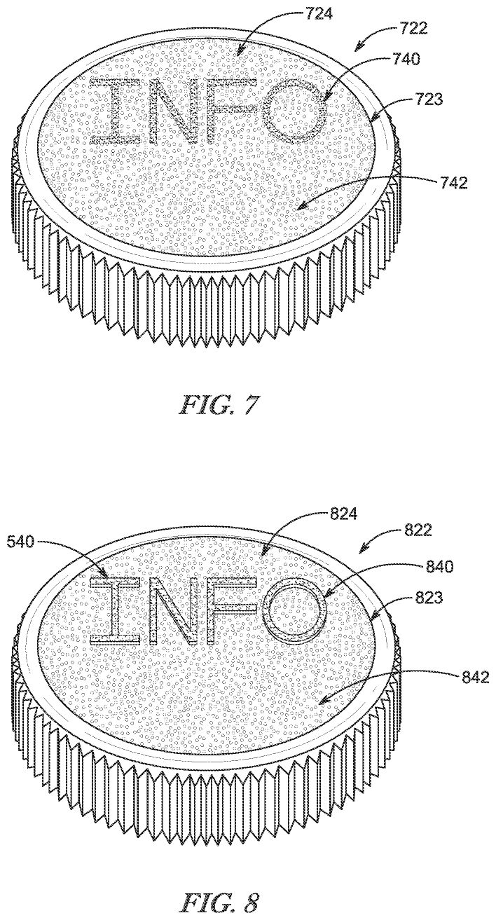

In some embodiments, the encoded visual indicia may visually provide information to a user without use of an optical camera 21 while also including the encoded visual indicia to display other information in augmented reality if the encoded visual indicia is scanned by an optical camera as suggested in FIGS. 7-9. The encoded visual indicia is formed into the polymeric article in a conspicuous location so as to be readily visible to the user and to communicate information visually thereto.

Another embodiment of an article preform 722 that is formed to include a first plurality of features 740 and a second plurality of features 742 that form the encoded visual indicia on an article 10 is shown in FIG. 7. The plurality of features 740, 742 are illustratively formed on a central article preform top wall 723, however, in other embodiments, the plurality of features 740, 742 may be formed on another part of the article preform 722. The first plurality of features 740 are arranged in a first pattern while the second plurality of features 742 are arranged in a second pattern different from the first pattern. Each pattern of features 724 is configured to display information in augmented reality when the encoded visual indicia is scanned by an optical camera.

The first pattern formed by the plurality of features 740 is arranged such that it is conspicuous to a user (i.e. a consumer of a product used with the polymeric article 10). The first pattern is configured to communicate a first piece of information to the user visually when the polymeric article 10 is viewed by the user without the use of an optical camera to scan the encoded visual indicia. Illustratively, the first pattern includes outer boundaries or edges that define text to visually convey the first piece of information to the user when the user visually observes the polymeric article. The text is arranged in the form of a word “INFO”, however it should be appreciated that the text may form any word, number, etc. to convey any type of information to the user visually. In one example, the information conveyed visually includes information about at least one of the polymeric article (i.e. materials), product used with the polymeric article (i.e. nutrition information), vendor information, manufacturer information, etc. The plurality of features 740 forming the first pattern may also be scanned by an optical camera to communicate a second piece of information to the user in augmented reality via a computing device such as the screen of mobile device 20. In other embodiments, the first pattern may include boundaries that define another type of visual information such as an icon or an image.

The second pattern formed by the second plurality of features 742 surrounds the first pattern formed by the first plurality of features 740. The first pattern is interspersed with the second pattern but only the first pattern includes defined boundaries in the shape of the first visual piece of information. The second pattern does not include any boundaries that visually define a piece of information so that the second pattern is visually inconspicuous to the user relative to the first pattern. The first pattern may be visually perceived by the user while the second pattern unperceived by the user because the second pattern does not include boundaries that define a piece of information. As such, the second pattern does not visually communicate information to a user, but may communicate information in augmented reality when the second pattern is scanned by an optical camera.

Illustratively, the first pattern 740 is shown with each feature being an open circle and the second pattern 742 is shown with each feature being a closed circle, however, it should be appreciated that these shapes are exemplary and any suitable shape may be used for features 740, 742. In some embodiments, the features 740, 742 are shaped similarly in both first pattern and second pattern and the arrangement of the features 740, 742 is different between first pattern and second pattern. In some embodiments, the features 740 of first pattern have a different shape than the features 742 of the second pattern 742. The plurality of features 740, 742 are repeated and have shapes similar to features 24 described above.

Both the first plurality of features 740 and the second plurality of features 742 are formed during the laser etching stage 106 to collectively provide encoded visual indicia 12 for more than one purpose. The first plurality of features 740 may be scanned by an optical camera of a consumer computing device 20 to generate a first set of instructions based on the first plurality of features 540 in the encoded visual indicia 12. The first set of instructions may cause the consumer computing device 20 to display information in augmented reality and that allows the user to interact with the augmented environment. Scanning the first plurality of features 740 may cause an image or text to be displayed on a screen of computing device 20, cause a sound to be played from a speaker connected with computing device 20, and/or cause the computing device to take a user to a predetermined website. The consumer computing device 20 may include memory with preprogrammed instructions such that the second plurality of features 742 is ignored by the consumer computing device 20 when scanned by the optical camera of the consumer computing device 20. In other embodiments, the second plurality of features 742 may have an arrangement that is unreadable from or ignored by the optical camera of a consumer computing device (i.e. a smartphone).

The second plurality of features 742 of encoded visual indicia 12 may be scanned by an optical camera of a second computing device (i.e. an industrial computing device) that is different from consumer computing device 20 to generate a second set of instructions based on the second pattern 742 in the encoded visual indicia 12. The second set of instructions may include information related to article 10 for recyclability purposes such as, for example, the materials from which article 10 is made so that the article 10 may be properly sorted during the recycling process. The second computing device may include memory with preprogrammed instructions such that the first plurality of features 740 is ignored from the optical camera of the industrial computing device. In other embodiments, the first plurality of features 740 may have an arrangement that is unreadable from or ignored by the optical camera of an industrial computing device.

Another embodiment of an article preform 822 including a first plurality of features 840 and a second plurality of features 842 configured to form encoded visual indicia on a polymeric article 10 is shown in FIG. 8. Article preform 822 is substantially similar to article preform 722 discussed above. Accordingly, similar reference numbers in the 800 series are used to describe common features between article preform 722 and article preform 822. The disclosure of article preform 722 is incorporated by reference for article preform 822 except for the differences discussed below.

The plurality of features 840, 842 form a first pattern and a second pattern, respectively. The plurality of features 840, 842 are illustratively formed on an article preform top wall 823, however, in other embodiments, the plurality of features 840, 842 may be formed on another part of the article preform 822. The first pattern and the second pattern formed by the plurality of features 840, 842 are the same as the first and second patterns formed by features 740, 742 on article preform 722. Article preform 822 further includes a raised embossment 841. The first plurality of features 840 are formed on the raised embossment 841 such that the first pattern and the raised embossment 841 provide outer boundaries or edges that define a first piece of information that is communicated visually to the user when the user observes the polymeric article 10. The raised embossment 841 may increase visibility of the first pattern relative to the second pattern to make the first pattern, and the visual information provided thereby, more conspicuous to the user. The embossment 841 is shown as being raised in the illustrative embodiment, however, it should be noted that the embossment may be a depression in other embodiments.

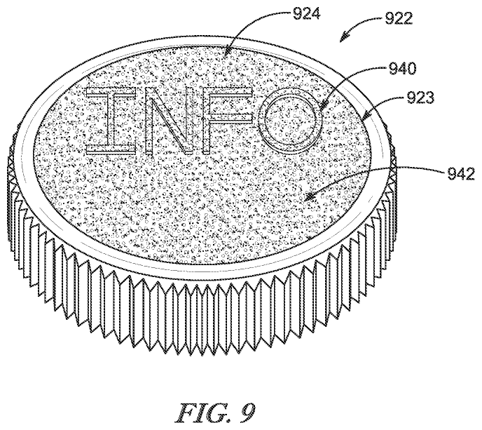

Another embodiment of an article preform 922 including a first plurality of features 940 and a second plurality of features 942 configured to form encoded visual indicia on a polymeric article 10 is shown in FIG. 9. Article preform 922 is substantially similar to article preform 722 discussed above. Accordingly, similar reference numbers in the 900 series are used to describe common features between article preform 722 and article preform 922. The disclosure of article preform 722 is incorporated by reference for article preform 922 except for the differences discussed below.

The plurality of features 940, 942 form a first pattern and a second pattern, respectively. The plurality of features 940, 942 are illustratively formed on an article preform top wall 923, however, in other embodiments, the plurality of features 940, 942 may be formed on another part of the article preform 922. The first pattern and the second pattern formed by the plurality of features 940, 942 are the same as the first and second patterns formed by features 740, 742 on article preform 722. While the first pattern and the second pattern formed by features 740, 742 are separate from one another as shown in FIG. 7, the first and second pattern formed by features 940, 942 are interspersed with one another as shown in FIG. 9. Accordingly, the first pattern and the second pattern both communicate information visually to the user while the area surrounding the text only communicates information in augmented reality when one or both of the first pattern and second pattern are scanned by an optical camera of a computing device.

Another article forming system 250 is shown in FIG. 10. The article forming system 250 includes a flatbed thermoformer 254 which forms a sheet 253 of polymeric material into a plurality of article preforms 260 and a carrier web 261. The article forming system 250 further includes a trimming unit 258 and a laser etching unit 256. The trimming unit 258 is configured to separate each article preform 260 from the carrier web 261 to provide a plurality of articles 210. The trimming unit 258 may also flip each article 210 to ready each article for laser etching by the laser etching unit 256.

The laser etching unit 258 is configured to form encoded visual indicia 212 on each of the articles 210 as shown in FIG. 10. The laser etching unit 258 includes one or more lasers 262, 262′, a laser actuator unit 264, and a control system 266. The lasers 262, 262′ are configured to produce a laser beam 259 which etches the encoded visual indicia 212 into a surface of each article 212. The laser actuator unit 264 is configured to move the laser beam 259 relative to the articles 210 as the lasers 262, 262′ are energized to form the encoded visual indicia 212 in a predetermined pattern. The control system 266 is configured to control operation of the lasers 262, 262′ and movement of the laser actuator unit 264. The control system 266 is coupled to a database 282 and/or sensor(s) 284 to receive information about the articles 210. The control system 266 is configured to adjust laser configuration based on the information so that the encoded visual indicia 212 is scannable as described above with regards to system 50.

It should be appreciated that each computing device described herein also includes a microprocessor, memory, and electrical circuitry. The microprocessor operates the computing device in response to signals and inputs into the computing device such as, for example, scanning encoded visual indicia 12 with an optical camera. The memory includes stored instructions that, when executed by the microprocessor, causes one or more of the instructions to execute on the computing device, such as, for example, generating the instructions described above on a screen of the computing device. The electrical circuitry interconnects all electrical components of the computing device so that signals and instructions can be transferred therebetween. In some embodiments, the electrical circuitry may include one or more antennas and transceivers for wireless communication of signals and instructions.

In illustrative embodiments, sheet 30 and, thus, thermoformed article 10 such as, for example, lid 10 is made with polymeric material. In some embodiments, the polymeric materials include one or more of polypropylene, ethylene, polyethylene, polylactic acid, polyactide, and polyethylene terephthalate. In some embodiments, polymeric materials include polystyrene. In some embodiments, polymeric materials include high impact polystyrene. In illustrative embodiments, article 10 is transparent.

In some embodiments, sheet 30 and, thus, thermoformed article 10 is made from non-aromatic polymeric materials such that article 10 is free from polystyrene. In other words, article 10 is free from aromatic materials in some embodiments. As used herein, the term non-aromatic polymer refers to a polymer that is devoid of aromatic ring structures (e.g., phenyl groups) in its polymer chain. A non-aromatic polymeric material is a polymeric material free of aromatic polymers, styrenenic polymers, or polystyrene. In illustrative examples, the non-aromatic polymeric materials include polypropylene.

Aromatic molecules typically display enhanced hydrophobicity when compared to non-aromatic molecules. As a result, it would be expected that a polypropylene-based polymeric material instead of a polystyrene-based polymeric material would result in a change in hydrophobicity with a concomitant, but not necessarily predictable or desirable, change in surface adsorption properties of the resulting material. In addition, by virtue of the hydrocarbon chain in polystyrene, wherein alternating carbon centers are attached to phenyl groups, neighboring phenyl groups can engage in so-called pi-stacking, which is a mechanism contributing to the high intramolecular strength of polystyrene and other aromatic polymers. No similar mechanism is available for non-aromatic polymers such as polypropylene. Moreover, notwithstanding similar chemical reactivity and chemical resistance properties of polystyrene and polypropylene, polystyrene can be either thermosetting or thermoplastic when manufactured whereas polypropylene is exclusively thermoplastic. As a result, to the extent that surface adsorption properties, manufacturing options, and strength properties similar to those of polystyrene are sought, likely alternatives to polystyrene-based polymeric materials would be found in another aromatic polymer rather than in a non-aromatic polymer.

The use of non-aromatic materials may affect recyclability, insulation, microwavability, impact resistance, or other properties. At least one potential feature of an article formed of non-aromatic polymeric material according to various aspects of the present disclosure is that the article can be recycled. Recyclable means that a material can be added (such as regrind) back into an extrusion or other formation process without segregation of components of the material, i.e., an article formed of the material does not have to be manipulated to remove one or more materials or components prior to re-entering the extrusion process. In contrast, a polystyrene article may not be recyclable. In one example, an article made from non-aromatic or styrene-free materials may simplify recycling.

The following numbered clauses include embodiments that are contemplated and non-limiting:

Clause 1. An article forming system includes an extruder configured to extrude a sheet of polymeric material.

Clause 2. The article forming system of clause 1, any other clause, or any suitable combination of clauses, further including a thermoforming device configured to form the sheet into a plurality of article preforms and a carrier web coupled to each of the article preforms.

Clause 3. The article forming system of clause 2, any other clause, or any suitable combination of clauses, further including a laser etching unit.

Clause 4. The article forming system of clause 3, any other clause, or any suitable combination of clauses, wherein the laser etching unit includes a laser configured produce a laser beam when energized to form encoded visual indicia into a surface of each of the plurality of article preforms.

Clause 5. The article forming system of clause 4, any other clause, or any suitable combination of clauses, wherein the laser etching unit includes a laser actuator unit configured to move the laser beam relative to the plurality of article preforms so that the laser forms the encoded visual indicia on the plurality of article preforms.

Clause 6. The article forming system of clause 5, any other clause, or any suitable combination of clauses, wherein the laser etching unit includes a control system including a processor and a memory storage device storing instructions that, when executed by the processor, cause the laser actuator unit to move the laser beam along a predetermined path and to cause the laser to energize in predetermined intervals as the laser beam advances along the predetermined path so that the encoded visual indicia is formed in the surface of the article preform in a pattern that is configured to be scanned by a computing device having an optical camera to cause the computing device to generate instructions based on the scanned encoded visual indicia.

Clause 7. The article forming system of clause 6, any other clause, or any suitable combination of clauses, wherein the control system is coupled to a database storing data including characteristics of the article preforms and the control system is configured to adjust at least one of laser intensity, laser beam focus, and laser distance from the article preform based on the characteristics of the article preforms.

Clause 8. The article forming system of clause 7, any other clause, or any suitable combination of clauses, wherein the characteristics include at least one of material composition and color of the article preforms.

Clause 9. The article forming system of clause 8, any other clause, or any suitable combination of clauses, wherein the control system is configured to cause the laser to produce a first laser intensity in response to receiving signals from the database that indicate that the article preforms have a black color and the control system is configured to cause the laser to produce a second laser intensity, less than the first laser intensity, in response to receiving signals from the database that indicate that the article preforms have a red or a yellow color.

Clause 10. The article forming system of clause 6, any other clause, or any suitable combination of clauses, wherein the control system is coupled to a sensor configured to send signals to the control system indicative of characteristics of the article preforms and the control system is configured to adjust at least one of laser intensity, laser beam focus, and laser distance from the article preform based on the characteristics of the article preforms.

Clause 11. The article forming system of clause 10, any other clause, or any suitable combination of clauses, wherein the sensor includes at least one of an optical sensor or an infrared sensor.

Clause 12. The article forming system of clause 10, any other clause, or any suitable combination of clauses, wherein the characteristics include at least one of material composition and color of the article preforms.

Clause 13. The article forming system of clause 12, any other clause, or any suitable combination of clauses, wherein the control system is configured output a first command signal to the laser to cause the laser to produce a first laser intensity in response to receiving signals from the sensor that indicate that the article preforms have a black color and the control system is configured to output a second command signal to the laser to cause the laser to produce a second laser intensity, less than the first laser intensity, in response to receiving signals from the sensor that indicate that the article preforms have a red or a yellow color.

Clause 14. The article forming system of clause 6, any other clause, or any suitable combination of clauses, wherein the article preforms are arranged in a grid on the carrier web, the grid having a plurality of columns and a plurality of rows, and wherein the laser etching system includes a plurality of lasers which are configured to form the encoded visual indicia on an article preform included in each column at the same time.

Clause 15. The article forming system of clause 14, any other clause, or any suitable combination of clauses, wherein the laser actuator unit includes a laser mount configured to support each of the plurality of lasers above each column of article preforms and a laser conveyor coupled to the laser support beam and a laser motor configured to drive reciprocating motion of each of the plurality of lasers along the laser conveyor in a transverse direction relative to a direction of travel of the article preforms so that each of the plurality of lasers moves in unison with one another.

Clause 16. The article forming system of clause 15, any other clause, or any suitable combination of clauses, wherein each of the plurality of lasers is configured to form a first pattern of encoded visual indicia on each of the article preforms.

Clause 17. The article forming system of clause 16, any other clause, or any suitable combination of clauses, wherein each of the plurality of lasers is configured to form a second pattern of encoded visual indicia on each of the article preforms different than the first pattern.

Clause 18. The article forming system of clause 15, any other clause, or any suitable combination of clauses, wherein the plurality of the lasers includes a first laser associated with a first column of article preforms and configured to form a first pattern of encoded visual indicia on the article preforms in the first column and a second laser associated with a second column of article preforms and configured to form a second pattern of encoded visual indicia on the article preforms in the second column that is different than the first pattern.

Clause 19. The article forming system of clause 6, any other clause, or any suitable combination of clauses, further comprising a trimming unit configured to separate each of the article preforms from the carrier web after the encoded visual indicia is formed on the plurality of article preforms to provide a plurality of polymeric articles.

Clause 20. A method of forming a polymeric article includes extruding a sheet of polymeric material.

Clause 21. The method of clause 20, any other clause, or any suitable combination of clauses, further including thermoforming the sheet of polymeric material to form a plurality of polymeric article preforms and a carrier web interconnecting each of the article preforms.

Clause 22. The method of clause 21, any other clause, or any suitable combination of clauses, further including laser etching a surface of each article preform to provide encoded visual indicia on the surface of each article preform that can be scanned by an optical camera to generate instructions on a computing device, and

Clause 23. The method of clause 22, any other clause, or any suitable combination of clauses, further including separating each of the article preforms from the carrier web to provide a plurality of polymeric articles having the encoded visual indicia formed thereon.

Clause 24. The method of clause 23, any other clause, or any suitable combination of clauses, wherein the step of laser etching includes determining characteristics of the article preforms including at least one of a material composition and a color of each article preform and adjusting laser intensity based on the characteristics.

Clause 25. The method of clause 24, any other clause, or any suitable combination of clauses, wherein the characteristics are determined by a sensor.

Clause 26. The method of clause 23, any other clause, or any suitable combination of clauses, wherein the step of laser etching includes etching a first portion of the encoded visual indicia at a first location with a first laser and etching a second portion of the encoded visual indicia at a second location downstream of the first location with a second laser.

Clause 27. The method of clause 23, any other clause, or any suitable combination of clauses, wherein the step of thermoforming includes forming a grid of article preforms having a plurality of columns and a plurality of rows, and wherein each row has a designated laser configured to form the encoded visual indicia on each article preform of each respective row.

Clause 28. The method of clause 27, any other clause, or any suitable combination of clauses, wherein a first laser is configured to form a first pattern of visual indicia on a first row of article preforms and a second laser is configured to form a second pattern of visual indicia on a second row of article preforms.

Clause 29. An article forming system includes a polymeric-article forming device configured to form a plurality of article preforms from polymeric material.

Clause 30. The article forming system of clause 29, any other clause, or any suitable combination of clauses, further including a laser etching unit.

Clause 31. The article forming system of clause 30, any other clause, or any suitable combination of clauses, wherein the laser etching unit includes a laser configured produce a laser beam when energized to form encoded visual indicia into a surface of each of the plurality of article preforms.

Clause 32. The article forming system of clause 31, any other clause, or any suitable combination of clauses, wherein the laser etching unit includes a laser actuator unit configured to move the laser beam relative to the plurality of article preforms so that the laser forms the encoded visual indicia on the plurality of article preforms.

Clause 33. The article forming system of clause 32, any other clause, or any suitable combination of clauses, wherein the laser etching unit includes a control system including a processor and a memory storage device storing instructions that, when executed by the processor, cause the laser actuator unit to move the laser beam along a predetermined path and to cause the laser to energize in predetermined intervals as the laser beam advances along the predetermined path so that the encoded visual indicia is formed in the surface of the article preform in a pattern that is configured to be scanned by a computing device having an optical camera to cause the computing device to generate instructions based on the scanned encoded visual indicia.

Clause 34. The article forming system of clause 33, any other clause, or any suitable combination of clauses, wherein the polymeric-article forming device includes a thermoformer.

Clause 35. The article forming system of clause 33, any other clause, or any suitable combination of clauses, wherein the polymeric-article forming device includes a rotary thermoformer.

Clause 36. The article forming system of clause 33, any other clause, or any suitable combination of clauses, wherein the polymeric-article forming device includes an injection molding machine.

Clause 37. The article forming system of clause 33, any other clause, or any suitable combination of clauses, wherein the polymeric-article forming device includes a blow-molding machine.

1. An article forming system comprising
an extruder configured to extrude a sheet of polymeric material,
a thermoforming device configured to form the sheet into a plurality of article preforms and a carrier web coupled to each of the article preforms, and
a laser etching unit including a laser configured produce a laser beam when energized to form encoded visual indicia into a surface of each of the plurality of article preforms, a laser actuator unit configured to move the laser beam relative to the plurality of article preforms so that the laser forms the encoded visual indicia on the plurality of article preforms, and a control system including a processor and a memory storage device storing instructions that, when executed by the processor, cause the laser actuator unit to move the laser beam along a predetermined path and to cause the laser to energize in predetermined intervals as the laser beam advances along the predetermined path so that the encoded visual indicia is formed in the surface of the article preform in a pattern that is configured to be scanned by a computing device having an optical camera to cause the computing device to generate instructions based on the scanned encoded visual indicia.

2. The article forming system of claim 1, wherein the control system is coupled to a database storing data including characteristics of the article preforms and the control system is configured to adjust at least one of laser intensity, laser beam focus, and laser distance from the article preform based on the characteristics of the article preforms.

3. The article forming system of claim 2, wherein the characteristics include at least one of material composition and color of the article preforms.

4. The article forming system of claim 3, wherein the control system is configured to cause the laser to produce a first laser intensity in response to receiving signals from the database that indicate that the article preforms have a black color and the control system is configured to cause the laser to produce a second laser intensity, less than the first laser intensity, in response to receiving signals from the database that indicate that the article preforms have a red or a yellow color.

5. The article forming system of claim 1, wherein the control system is coupled to a sensor configured to send signals to the control system indicative of characteristics of the article preforms and the control system is configured to adjust at least one of laser intensity, laser beam focus, and laser distance from the article preform based on the characteristics of the article preforms.

6. The article forming system of claim 5, wherein the sensor includes at least one of an optical sensor or an infrared sensor.

7. The article forming system of claim 5, wherein the characteristics include at least one of material composition and color of the article preforms.

8. The article forming system of claim 7, wherein the control system is configured output a first command signal to the laser to cause the laser to produce a first laser intensity in response to receiving signals from the sensor that indicate that the article preforms have a black color and the control system is configured to output a second command signal to the laser to cause the laser to produce a second laser intensity, less than the first laser intensity, in response to receiving signals from the sensor that indicate that the article preforms have a red or a yellow color.

9. The article forming system of claim 1, wherein the article preforms are arranged in a grid on the carrier web, the grid having a plurality of columns and a plurality of rows, and wherein the laser etching system includes a plurality of lasers which are configured to form the encoded visual indicia on an article preform included in each column at the same time.

10. The article forming system of claim 9, wherein the laser actuator unit includes a laser mount configured to support each of the plurality of lasers above each column of article preforms and a laser conveyor coupled to the laser support beam and a laser motor configured to drive reciprocating motion of each of the plurality of lasers along the laser conveyor in a transverse direction relative to a direction of travel of the article preforms so that each of the plurality of lasers moves in unison with one another.

11. The article forming system of claim 10, wherein each of the plurality of lasers is configured to form a first pattern of encoded visual indicia on each of the article preforms.

12. The laser forming system of claim 11, wherein each of the plurality of lasers is configured to form a second pattern of encoded visual indicia on each of the article preforms different than the first pattern.

13. The article forming system of claim 10, wherein the plurality of the lasers includes a first laser associated with a first column of article preforms and configured to form a first pattern of encoded visual indicia on the article preforms in the first column and a second laser associated with a second column of article preforms and configured to form a second pattern of encoded visual indicia on the article preforms in the second column that is different than the first pattern.

14. An article forming system comprising
a polymeric-article forming device configured to form a plurality of article preforms from polymeric material and
a laser etching unit including a laser configured produce a laser beam when energized to form encoded visual indicia into a surface of each of the plurality of article preforms, a laser actuator unit configured to move the laser beam relative to the plurality of article preforms so that the laser forms the encoded visual indicia on the plurality of article preforms, and a control system including a processor and a memory storage device storing instructions that, when executed by the processor, cause the laser actuator unit to move the laser beam along a predetermined path and to cause the laser to energize in predetermined intervals as the laser beam advances along the predetermined path so that the encoded visual indicia is formed in the surface of the article preform in a pattern that is configured to be scanned by a computing device having an optical camera to cause the computing device to generate instructions based on the scanned encoded visual indicia.

15. A method of forming a polymeric article, the method comprising steps of:
extruding a sheet of polymeric material,
thermoforming the sheet of polymeric material to form a plurality of polymeric article preforms and a carrier web interconnecting each of the article preforms,
laser etching a surface of each article preform to provide encoded visual indicia on the surface of each article preform that can be scanned by an optical camera to generate instructions on a computing device, and
separating each of the article preforms from the carrier web to provide a plurality of polymeric articles having the encoded visual indicia formed thereon.

16. The method of claim 15, wherein the step of laser etching includes determining characteristics of the article preforms including at least one of a material composition and a color of each article preform and adjusting laser intensity based on the characteristics.

17. The method of claim 16, wherein the characteristics are determined by a sensor.

18. The method of claim 15, wherein the step of laser etching includes etching a first portion of the encoded visual indicia at a first location with a first laser and etching a second portion of the encoded visual indicia at a second location downstream of the first location with a second laser.

19. The method of claim 15, wherein the step of thermoforming includes forming a grid of article preforms having a plurality of columns and a plurality of rows, and wherein each row has a designated laser configured to form the encoded visual indicia on each article preform of each respective row.

20. The method of claim 19, wherein a first laser is configured to form a first pattern of visual indicia on a first row of article preforms and a second laser is configured to form a second pattern of visual indicia on a second row of article preforms.
